(19) United States
(12) Patent Application Publication
(10) Pub. No.: US 2021/0078364 A1
(43) Pub. Date: Mar. 18, 2021

(54) Spindle Nut Cap

(71) Applicant: Dexter Axle Company, Elkhart, IN (US)

(72) Inventors: Samuel Neil Lievore, Elkhart, IN (US); Markus Cloyd Carrison, Goshen, IN (US)

(73) Assignee: Dexter Axle Company, Elkhart, IN (US)

(21) Appl. No.: 16/572,962

(22) Filed: Sep. 17, 2019

(51) Int. Cl. B60B 35/00; B60B 35/02

(52) U.S. Cl. CPC B60B 35/004; B60B 35/02; B60G 7/001; B60B 2900/211; B60B 2900/511; B60B 2900/141

(57) ABSTRACT

A cap is provided for covering the threaded end of a removable spindle, having a cover with thread engaging tabs extending from a reservoir basin. The tabs include surface projections for retaining the cap to the spindle threads. The tabs are formed to fit within available slots of a slotted hex nut connected to the spindle. The cap includes a separately formed skirt or guard to make flexible surface contact with the torsion arm or spindle supporting structure. The skirt can include a sacrificial anode region to provide cathodic protection for the spindle threads and spindle retention nut. The skirt is removable from the cap so that the cap can be reused with a new skirt. The cap is formed to be used with existing spindle assemblies and to be reusable.

### BACKGROUND OF THE INVENTION

The present invention relates generally to protection of removable spindles, and more particularly, to such spindles used with axle assemblies for vehicles, including towed trailers, such as boat (marine) trailers.

In general, marine trailers often use wheels mounted on spindle axles. Arrangements such as the design shown in U.S. Pat. No. 6,299,259 can function well for that purpose. However, due to occasional overloading, component corrosion, debris impact, and/or wear and tear, it is desirable to be able to remove the spindle and repair or replace it, rather than replace the entire axle assembly. Unfortunately, since some spindle assemblies are exposed to salt water and other environmental factors, component corrosion can severely inhibit spindle replacement. In particular, the nut which secures the spindle to the torsion arm, and/or the threaded portion of the spindle to which that nut is attached, can be prone to such corrosion. Corrosion of those components directly inhibits spindle replacement.

Previously, it has been suggested to merely attach a cap to the spindle to protect against such corrosion. One example is shown in U.S. Patent Application Publication US 2018/0162163. However, that structure would require significantly greater expense (as, for example, from machining or casting of the torsion arm to form a cap slot or groove), can be limited in applications to where cotter pins are not applied as a nut lock, can fail to provide the versatility and reliability sufficient to justify the cost of product reconfiguration, and can adversely affect the structural integrity of the underlying components.

Also, it is desirable to have readily visible indicia of the level of corrosion developing on spindle axle assemblies or other component degradation events, so as to facilitate timely maintenance and/or component replacement. Over-arching cap structures can actually inhibit use of such indicia, as well as inhibit ready joint inspection by the user. An improved device is needed.

Further, it is desirable to allow spindle axle protection covers to be easily retrofitted into existing spindle axle assemblies, and without having to remove the spindle axle assembly components from the trailer in order to install. Preferably, whatever protection device is needed would be merely a direct, add-on component, having a significantly lower cost than the components it is designed to protect.

The present invention is a cap for covering and protecting the threaded end of a removable spindle. The cap has a cover with thread engaging tabs extending from a reservoir basin for dispensing corrosion inhibiting and/or lubricating material onto the spindle. The tabs include surface projections for retaining the cap to the spindle threads. The tabs are formed to fit within available slots of a slotted hex nut connected to the spindle (for retaining the spindle to a support structure). The cap further includes a flexible skirt or guard to make flexible surface contact with the torsion arm or spindle supporting structure. The skirt may include a sacrificial anode region to provide cathodic protection for the spindle threads and spindle retention nut, and/or visual indicia for recommended spindle maintenance or inspection. The skirt may be removable from the cap so that the cap could be reused with a new skirt. The cover portion of the cap can include integrally formed or topically applied visual indicia to indicate when recommended spindle maintenance or inspection is needed, according to the degradation of that indicia over time or exposure to adverse usage environments. The cap is formed to be used with existing spindle assemblies and to be reusable.

Other objects, advantages, and novel features of the present invention will become readily apparent from the following drawings and detailed description of certain preferred and alternative embodiments.

### SUMMARY OF THE INVENTION

Accordingly, a primary objective of the present invention is to provide an improved cap for spindle axle assemblies, particularly where the spindle is removable from a vehicle. These improvements include providing apparatus for retaining a nut cap to a removable spindle which is inexpensive to manufacture, use, and maintain. Other objectives include: facilitate visual inspection of the spindle assembly, minimize component weight, allow reuse, reliably retain the nut to the spindle against various forces acting upon the nut and spindle during use, is retrofittable with existing spindle axle assemblies, include active corrosion inhibitors, and is reliable in vehicular and marine trailer applications.

### BRIEF DESCRIPTION OF THE DRAWINGS

FIG. 1 is a top view of a removable spindle as attached torsion arm with the cap applied;

FIG. 2 is an exploded top view of the apparatus of FIG. 1;

FIG. 3A is a cross-sectional view along line 3A of FIG. 1;

FIG. 3B is a partial view 3B of FIG. 3A;

FIG. 4 is a cross-sectional view along line 4 of FIG. 2;

FIG. 5 is an inside isometric view of the cap of FIG. 1;

FIG. 6 is a side view of the cap of FIG. 1;

FIG. 7 is an exploded side section view 4 of the cap of FIG. 2;

FIG. 8 is an exploded inside isometric view of the cap; and

FIG. 9 is an isometric section view 9 of the apparatus of FIG. 3A.

### DESCRIPTION OF THE PREFERRED EMBODIMENT

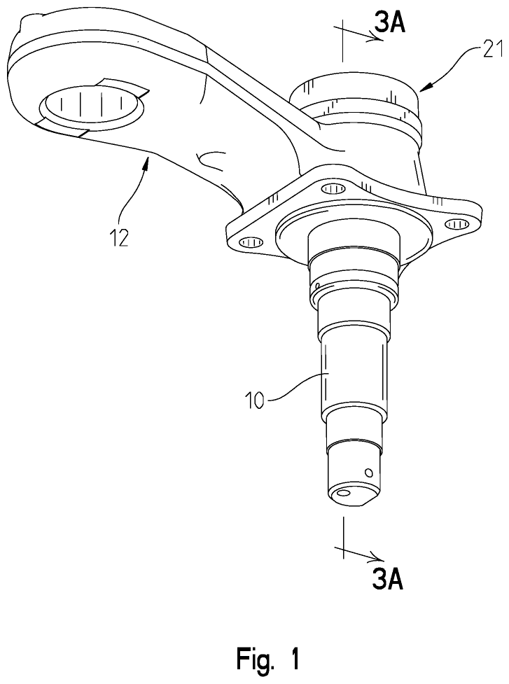

FIG. 1 shows the present invention, as applied to a spindle axle assembly. Various other applications of the present invention are specifically envisioned, both in vehicular applications, such as towable trailers for cargo and recreational use, and in spindles mounted within static structures. In general, the spindle 10 is removably mounted into the torsion arm 12 (swing arm, axle, or other structure which receives and supports the spindle). Thus, when needed, the spindle 10 can be serviced and/or replaced without replacement of the entire axle assembly. An example of typical structure use of these spindle axle assemblies is found in U.S. Pat. No. 6,299,259, and that disclosure is incorporated herein by reference as background information. The present invention includes the use of a cap covering the spindle end and protecting it from debris and corrosion.

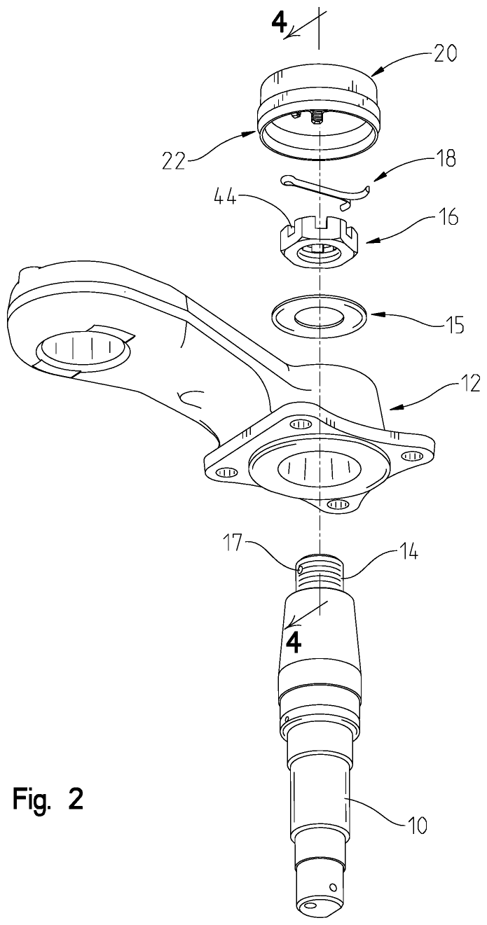

FIG. 1 shows a spindle 10, generally cylindrical and longitudinally extending between a support structure and a wheel (not shown) or other rotatable object. The spindle 10 is attached to a torsion arm 12, serving as the support structure and receiver for the spindle 10. The spindle 10 has a threaded end region 14, formed at an end of spindle 10, which is received into and passes through torsion arm 12. A threaded nut 16 has a mating threaded pattern on its interior circumference surface, so as to be removably threaded onto threaded end region 14 of spindle 10. The nut 16 is formed as a hex nut with slotted sides, otherwise known as a castellated nut. A castellated nut 16 has a series of slots 44. As shown in the FIGS., nut 16 is formed with six slots 44, two of which are occupied by cotter pin 18 passing through the end portion of spindle 10 by means of cotter pin hole 17. Other types of pins 18 are contemplated, such as an R-clip, split pin, hitch pin, linchpin, spring pin, bow tie cotter pin, hair pin cotter, or other nut retaining device that extends through the cotter pin hole 17. As shown in FIG. 2, a washer or retention disk 15, formed to be slid over and closely fit to threaded end region 14 to restrain spindle 10 in abutment with and against removal from torsion arm 12, when nut 16 is fully seated onto threaded end region 14. The spindle 10 has a cotter pin hole 17, formed to pass through spindle 10, and preferably located to align with two opposing slots in nut 16 when nut 16 is fully seated onto threaded end region 14. A cotter pin 18, formed to pass through those two opposing slots 44 of nut 16 and the cotter pin hole, to prevent counter-rotation of nut 16 away from its fully seated location on threaded end region 14 and spindle 10.

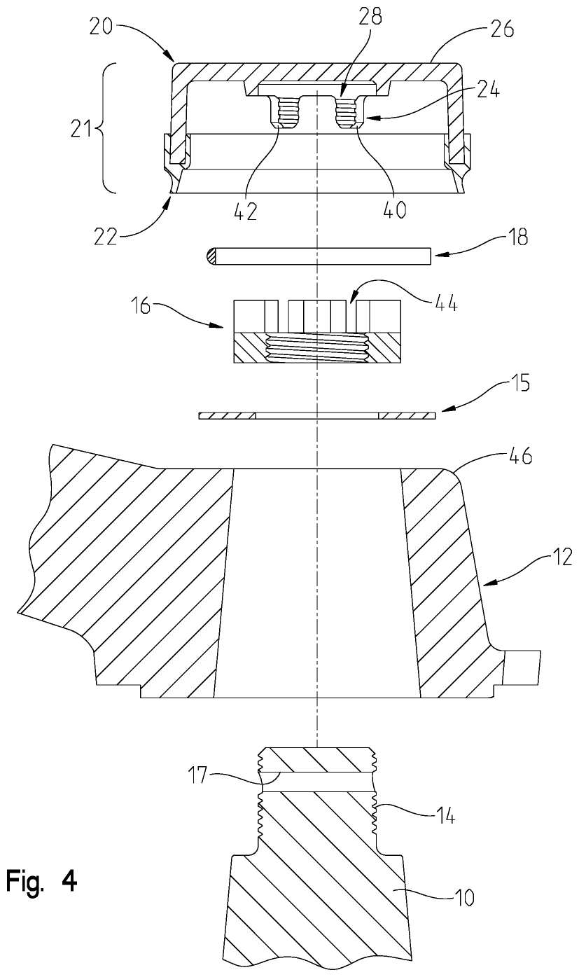

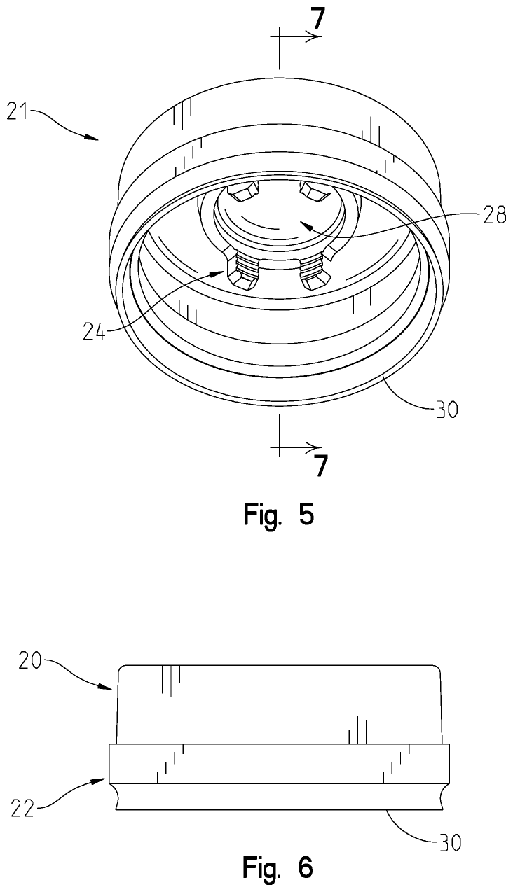

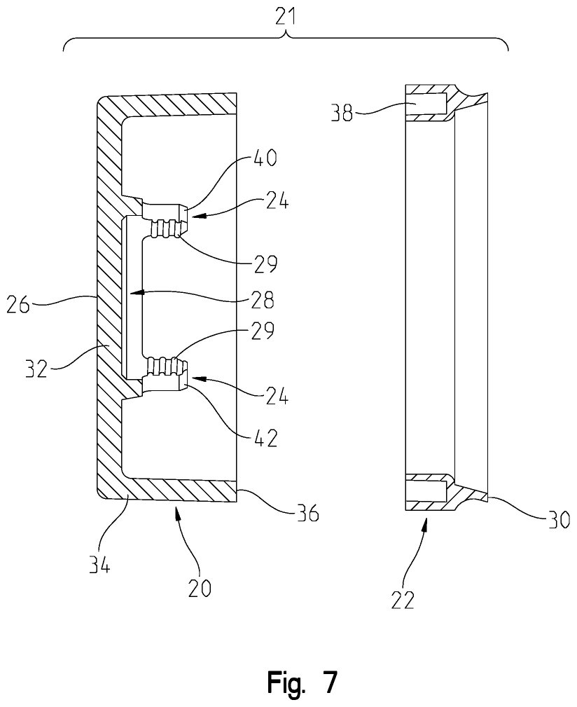

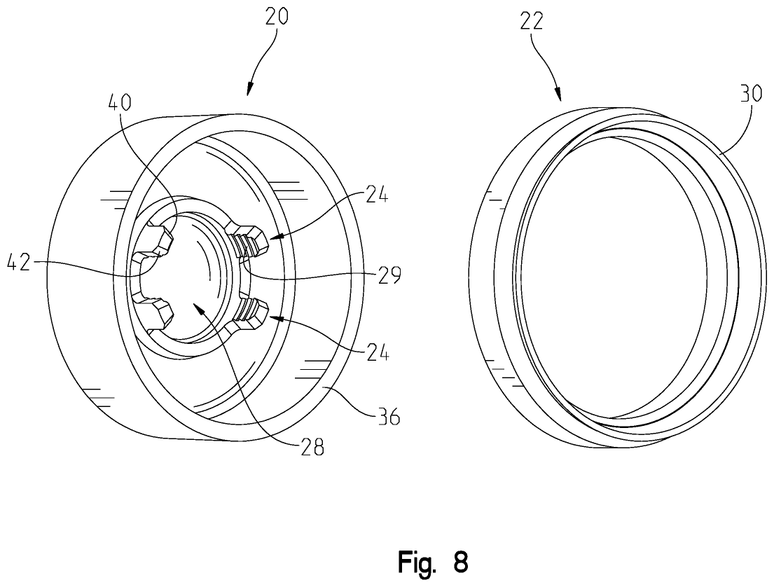

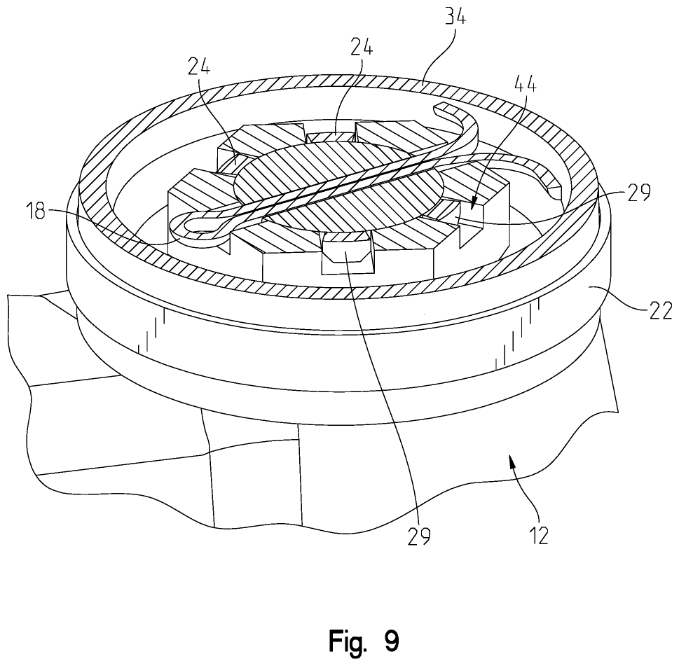

The cap 21 has two distinct portions, a cover 20 and a guard or skirt 22, which can be integrally formed as a single element, or separately formed from multiple pieces so as to optimize components and costs, and permit reusability of the cover 20. The cover has an end wall portion 32 that extends to a perimeter wall portion 34 to form a bowl or cup shape. The spindle retainer portion is mounted within and to the underside of cover 20, including, for example, a plurality of spaced apart tabs 24 for engaging the exterior surface of spindle 10, preferably in the threaded end region 14, with four such tabs being shown in FIGS. 5 and 8. The cover 20 is cup shaped with a top surface 26, forming an exposed end when the cap 21 is mounted to the spindle assembly. The top surface 26 is visually perceptible to users. A reservoir 28 or reservoir portion on the underside of cover 20 and, preferably defined between tabs 24, which can be used to dispose and contain therein a corrosion inhibiting and/or lubricating material (such as conventional axle grease) prior to and/or during application of the cap to the spindle assembly, although in preferred embodiments, the end of spindle 10 will at least slightly penetrate reservoir 28 when the cap 21 is fully mounted onto the spindle assembly, thereby forcing distribution of at least a portion of the material contained therein onto the spindle 10, such as on at least threaded end region 14. Protrusions 29 on tabs 24, shown in FIGS. 7 and 8, are segments of inwardly directed teeth, cuts, ridges or the like (from relatively rigid or flexible material, according to a given application) which are intended to rest, at least in part, within the thread valleys of threaded end region 14 and resist forces which would otherwise move or loosen the cap off of the spindle assembly. The protrusions 29 allow the user to install and remove the cap 21 by applying sufficient force to cause the tabs 24 to flex as the protrusions 29 slide over the threads on the threaded end region 14. The perimeter wall portion 34 has a spindle facing surface 36 that is located oppositely the top surface 26. The skirt 22 bottoms out on the spindle facing surface 36 to set its position relative to the cover 20.

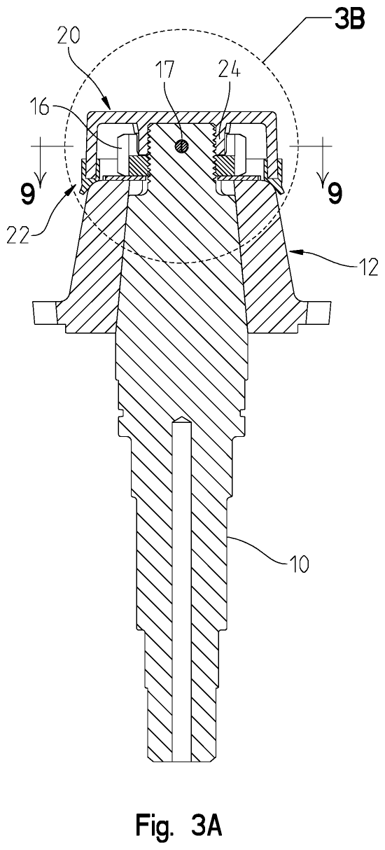

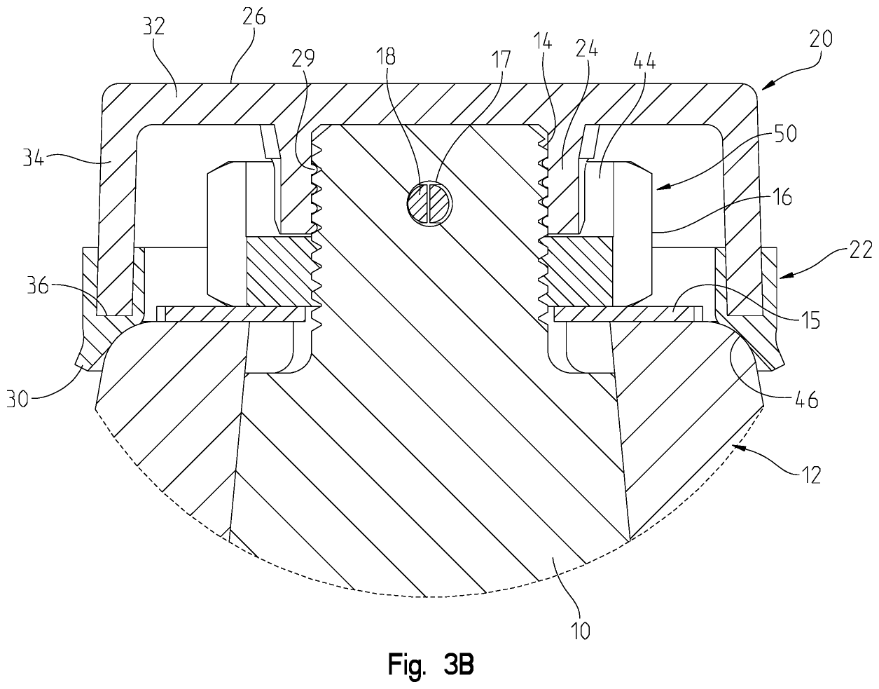

The skirt 22 includes a peripheral region 30 which faces the surface 46 of torsion arm 12 when the cap 21 is fully mounted onto the spindle assembly. The surface 46 is commonly not machined and/or does not have any controls as to the surface finish requirements. In some embodiments, the swing arm 12 is a cast component that has a rough surface. In other embodiments, the swing arm 12 may be a welded assembly with a weld joint, weld splatter, or rough-cut surfaces. The peripheral region 30 is designed to seal to that uncontrolled surface. In the event that the surface 46 is machined or otherwise controlled, the skirt 22 will also seal. That peripheral region 30, as shown, is shaped like a lip seal that is formed from flexible and resilient material, so that it can conform to the surface topography of the torsion arm about the area where the spindle is received and allow the cap 21 to prevent or reduce debris and corrosive fluid from contact with the surface of spindle 10 and retaining nut 16. To retain the skirt 22 to the cover 20, it has a pocket 38 that receives the perimeter wall portion 34. It may be advantageous to form skirt 22 entirely from such material, and in other embodiments it may be sufficient to form only the portions of skirt 22 furthest from top surface 26 (or closest to torsion arm 12) from such material. The amount of flexibility and resiliency of this material can be readily selected depending upon the degree of variation in surface topography or roughness of the torsion arm finish. The skirt 22 can allow the cap 21 to effectively seal against existing torsion arms (and similar supports for spindles) without the need for specially formed grooves or slots in the torsion arm 12. This can aid in retrofitting the cap 21 to removable spindle assemblies in the field. As installed, the cap 21 and the swing arm 12 form an enclosed chamber 50, shown in FIG. 3B. The enclosed chamber 50 is sealed from the outside environment by the skirt 22 sealing to the surface 46 of the spindle 12.

As shown, the skirt 22 can be connected to cover 20 via a close interference fit between the pocket 38 and perimeter wall portion 34, especially in certain applications where the environment will not result in adverse dimensional change of those elements (such as may be caused by wide temperature variations and/or excessive vibration with certain plastic or metal components). Alternatively, skirt 22 and cover 20 can be joined by friction or ultrasonic welding, or by adhesives. Further, there are certain applications of the present invention where it is desirable for skirt 22 and cover 20 to be removably connected, such as by a frangible connection in either one piece or two piece constructions, or by twisting off the interference fit in a two piece construction. Such separability can allow either cover 20 and/or skirt 22 to be reused in connection with caps for spindle assemblies.

Given the salt water environment for some applications of the cap 21, it can be advantageous to include cathodic protection features. For example, in order to limit the corrosive effects of the environment upon threaded end region 14, nut 16, cotter pin hole 17 and/or cotter pin 18, skirt 22 can be formed from a sacrificial metal which acts as a sacrificial anode. When present, the corrosion caused by the environment would occur earlier and/or more extensively at the guard/torsion arm interface, than at the internal components. Alternatively, the sacrificial metal or another anode suitable material can be applied as a surface treatment to skirt 22 over its entire surface or over a portion thereof, such as at the peripheral region closest to the torsion arm 12. One example of this would be to apply an aluminum film layer over a plastic molded skirt 22. In applications where the cap 21 is to be reused, at least in part, a skirt 22 which is “spent” by such cathodic protection can be replaced with a new skirt 22 mounted or attached onto cover 20. Alternatively, a spent skirt 22 can be cleaned and retreated with a surface anode, particularly where the anode was applied initially by a surface coating.

Further, cathodic protection can be extended into other components used with the cap 21. For example, the relative dimensions of washer 15 and skirt 22 are established so that when the cap is fully mounted onto the spindle axle assembly, the peripheral region of skirt 22 adjacent torsion arm 12 is also in close proximity to (or in contact with) the circumferential edge of washer 15. In those applications, it can be advantageous for washer 15, at least in a region close to its circumferential edge, to have a sacrificial anode as well, such as by a surface coating or metallic composition of the washer itself. This can provide additional protection to the threaded interface between spindle 10 and nut 16, which facilitates ease of removal of spindle 10 from torsion arm 12 whenever removal is desired by the user. Alternatively, an anode sheet or film can be applied adjacent the washer for this purpose. Further, where the sacrificial anode of skirt 22 and washer 15 are in close proximity, the corrosion “growth” on the anode can merge together from those elements and create more of a mechanical barrier between the environmental fluids and threaded end region 14. In effect, this can reduce the effect of corrosive salt water coming into contact with the spindle threads in certain applications of the present invention.

It may be advantageous to have at least a portion of skirt 22 which includes a sacrificial anode be readily visible to users on exterior of the cap. In this way, visible indicia of the extent of corrosion can be easily seen without removing the cap until needed. If sufficient corrosion is then seen, the cap can be replaced and/or serviced (along with the spindle assembly as needed) in a timely manner. The visual indication of the need for removal can be facilitated, for example, by selecting the anode material to change color or incur significant deformation when the desired level of corrosion has occurred to denote servicing of the cap and/or spindle assembly.

Alternatively (or additionally), cover 20 can be formed with or have applied to its surface, visual indicia of significant corrosion and/or the passage of time, by the selection of materials in its composition or by having a label adhesively mounted to end or top surface 26. Such a label can be formed from a similar anodic material as is used for cathodic protection with skirt 22. Alternatively (or additionally), the label include a visual marker which changes color distinctively in response to a predetermined passage of time and/or immersion in the usage environment. That change can be a signal to the user that replacement and/or servicing of the cap is needed to refill the corrosion inhibiting or lubrication material disposed in reservoir 28. Further, in applications of the present invention where the cover 20 is not intended to be reused, the visual indicia to indicate time for such servicing can be incorporated into the cover structure itself, and a new cover would be used after the servicing. Top surface 26 can also serve to contain or support a brand or part identifier, so as to ensure the user of genuine servicing standards for the spindle assembly.

In order to secure the cap to the spindle assembly and fully seat skirt 22 against torsion arm 12, the user aligns the tabs 24 with the unused slots 44 and then applies force to push the cap 21 towards the spindle 10. Each tab 24 has chamfer surfaces 40, 42 that help to guide the tabs 24 into the slots 44 of the nut 16. If aligned properly, the plurality of tabs 24 will temporarily flex apart upon receiving threaded end region 14, and then grip the spindle threads and resist unintended removal of the cap from the spindle threads. Because the tabs 24 reside in the slots 44, the cover 20 cannot loosen by unscrewing. The cover 20 is dimensioned to accommodate whichever form of cotter pin is desired for a particular spindle assembly. The remaining four slots 44 in nut 16 are used by tabs 24, which enter those slots 44 and grip the exposed portions of threaded end region 14. The number and size of protrusions 29 associated with teach tab 24 can be selected as appropriate to the nature of the threading of spindle 10 within threaded end region 14.

In other embodiments, tabs 24 can be greater in number or dimensionally extended and/or merged together as needed for full threading contact about the circumference of threaded end region 14. This would be appropriate, for example, if the cap 21 is to be secured to spindle above the nut 16. Alternatively, cover 20 can be formed with a conventional “push nut” type of element rather than tabs 24, for use in removably retaining the cap to the spindle.

Although the present invention has been shown and described herein with respect to certain preferred embodiments and alternative configurations, those were by way of illustration and example only. For example, tabs 24 can be formed with ferrule inner surfaces in place of protrusions 29, thereby preventing reuse and requiring a new cover 20. This arrangement can be useful as indicia of unauthorized spindle servicing.

It is understood that while certain aspects of the disclosed subject matter have been shown and described, the disclosed subject matter is not limited thereto and encompasses various other embodiments and aspects. No specific limitation with respect to the specific embodiments disclosed herein is intended or should be inferred. Modifications may be made to the disclosed subject matter as set forth in the following claims.

What is claimed is:

1. A cap for use with a removable spindle secured to a swing arm by a castellated nut, said castellated nut having slots to receive a cotter pin, said removable cap restricting access of fluid to a threaded end region of said removable spindle and said nut when said removable spindle is affixed to a swing arm, said cap comprising:
a single piece cover having an end wall portion extending to a perimeter wall portion, said end wall portion having a spindle retainer portion formed to receive and retain said threaded end of said spindle, said spindle retainer portion having tabs extending in a direction parallel to said perimeter wall portion, said tabs for being located within said slots of said castellated nut, said tabs having protrusions for mating with said threaded end of said removable spindle;
a resilient skirt sealably retained to said cover, said resilient skirt formed for biased contact with an outer surface of said swing arm to seal said threaded end of said spindle;
when said cap is retained by said spindle and said skirt is in biased contact with said surface of said swing arm, said cap and said spindle form an enclosed volume sealed from an outside environment; and
said cap is constrainable from rotation with respect to said spindle by said tabs engaging with said slots in said castellated nut and axially retainable to said spindle by said protrusions engaging with said threaded end region.

2. The cap according to claim 1, wherein said tabs are formed to flex apart to receive said spindle therebetween when said cap is mounted onto said spindle.

3. The cap according to claim 1, wherein said spindle retainer portion includes four tabs for engaging four of said slots of said castellated nut, said tabs allowing clearance for a cotter pin received by a hole in said threaded end region.

4. A cap for use with a removable spindle secured to a swing arm by a castellated nut having slots, said cap comprising:
a cover formed to receive a threaded end of said spindle, said cover having a spindle retainer portion formed from tabs integrally formed within said cover, said tabs for mating with said slots in said castellated nut, said tabs having protrusions for mating with said threaded end of said removable spindle;
a resilient skirt sealably retained to said cover, said resilient skirt formed for biased contact with said swing arm to seal said threaded end of said spindle;
said cap for restricting access of fluid to a threaded end region of said removable spindle and said castellated nut when said removable spindle is affixed to said swing arm; and
said cap is constrainable from rotation with respect to said spindle by said tabs engaging with said slots in said castellated nut and axially retainable to said spindle by said protrusions engaging with said threaded end region.

5. The cap according to claim 4, wherein said skirt is connected to said cover via an interference fit between a pocket on said skirt and a perimeter wall portion on said cap.

6. The cap according to claim 4, wherein said skirt is permanently affixed to said cover.

7. The cap according to claim 4, wherein said cap includes sacrificial corrosion indicia, exteriorly disposed for visual inspection.

8. The cap according to claim 4, wherein said cap and said spindle form an enclosed volume when said cap is retained by said spindle and said skirt is in biased contact with a surface of said swing arm, said enclosed volume is sealed from an environment outside of said enclosed volume.

9. The cap according to claim 4, wherein said spindle retainer portion includes four tabs for engaging four of said slots of said castellated nut, said tabs allowing clearance for a cotter pin received by a hole in said threaded end region.

10. The cap according to claim 4, further comprising a reservoir for dispensing corrosion inhibiting material when said cap is attached to said spindle.

11. A cap for sealing an end of a removable spindle, said removable spindle held to an axle member with a threaded nut engaging threads on a threaded end of said removable spindle, said cap comprising:
a single piece cover having an end wall portion integrally affixed to a perimeter wall portion, said end wall portion having a plurality of tabs extending therefrom, each of said tabs having protrusions forming portions of threads, said portions of said threads cooperating for engaging said threaded end of said removable spindle;
a skirt sealed to said perimeter wall portion of said single piece cover, said skirt having a resilient peripheral region extending therefrom, said resilient peripheral region for sealing to said axle member when said single piece cover is mated to said removable spindle.

12. The cap according to claim 11, wherein said axle member is a torsion arm.

13. The cap according to claim 11, further comprising a washer held by said threaded nut, said washer is formed to provide cathodic protection against corrosion of said threaded end and said threaded nut, said cathodic protection from at least a portion of said washer formed from sacrificial metal acting as an anode.

14. The cap according to claim 11, wherein said threaded nut is formed as a castellated nut having a plurality of slots, a cotter pin to pass through said spindle within at least two slots of said castellated nut, said cotter pin for inhibiting rotation of said nut with respect to said spindle, and said tabs spaced apart for engaging said threaded portion of said spindle between at least two of said other slots of said castellated nut where said cotter pin does not pass through.

15. The cap according to claim 11, wherein said cap is constrained from rotation with respect to said spindle by said tabs engaging with said slots between castellations in said castellated nut and axially retained to said spindle by said threaded end region engagement with said protrusions.

16. The cap according to claim 11, wherein said tabs are formed to flex apart to receive said spindle therebetween when said cap is mounted onto said spindle.

17. The cap according to claim 11, wherein said cap and said spindle form an enclosed volume when said cap is retained by said spindle and said skirt is in biased contact with a surface of said axle member, said enclosed volume is sealed from an outside environment.

18. The cap according to claim 17, wherein said cap includes a material which can act as a sacrificial anode to provide cathodic protection for said enclosed volume.

19. The cap according to claim 17, further comprising a reservoir for dispensing corrosion inhibiting material when said cap is attached to said spindle.
